(19) United States
(12) Patent Application Publication
(10) Pub. No.: US 2009/0165348 A1
(43) Pub. Date: Jul. 2, 2009

(54) Display Means

(76) Inventor: Robert Aberg, Anderstorp (SE)

Correspondence Address: NIXON & VANDERHYE, PC, 901 NORTH GLEBE ROAD, 11TH FLOOR, ARLINGTON, VA, 22203, US

(21) Appl. No.: 12/086,049

(22) PCT Filed: Dec. 6, 2006
(86) PCT No.: PCT/SE2006/050549

§ 371 Date: Jan. 15, 2009

(30) Foreign Application Priority Data
Dec. 8, 2005 (SE) 0502702-4

(51) Int. Cl. G09F 15/00

(52) U.S. Cl. 40/610

(57) ABSTRACT

The present invention relates to a display means comprising a stand adapted to secure a screen. The stand comprises a first part which supports against an underlying supportive surface and comprises a bobbin enclosed in a cavity in the first part. The screen can be wounded onto and withdrawn from the bobbin. The stand also comprises a telescopic pole means comprising an inner tube and an outer tube, which tubes telescopically can be moved in relation to each other. The stand also comprises a lock means arranged on the inner tube and operable to releasably lock the tubes in relation to each other, a coupling means arranged at a first end of the inner tube and operable to secure the screen when it is at least partly withdrawn from the bobbin, and a damper means comprising a first part arranged on the inner tube, and a second part arranged on the outer tube. The damper means is operable to exert a damping force when the tubes are moved in relation to each other with at least a predetermined threshold velocity value.

### TECHNICAL FIELD OF THE INVENTION

The present invention relates generally to a display means and, for instance, more particularly to a display means that includes a readily collapsed and readily erected stand, where the stand used can be adapted to secure a flexible information-presenting screen when in its erected state, and by flexible being meant that the screen can be rolled up onto and unrolled from a bobbin or a rod, normally in the form of a hollow-cylindrical body.

### BACKGROUND OF THE INVENTION

A telescopic pole with a lock means can be used for holding the printed graphics/screen in a display means (roll up/retractable banner stands) (e.g. Expand QuickScreen). The advantage is that the telescopic pole enables the graphics to be continuously adjusted to a desirable height/size. However, the lock means can be opened by mistake and then the graphics risk to get damaged when the roll up mechanism is pulling the graphics with a high speed in an uncontrollable manner into the cassette.

### SUMMARY OF THE INVENTION

It is an object of the present invention to solve the above mentioned problem. This is achieved with a display means according to Claim 1. The display means comprises a stand adapted to secure a screen. The stand comprises a first part which supports against an underlying supportive surface, and comprises a bobbin enclosed in a cavity in said first part. The screen can be wound onto and withdrawn from said bobbin. The stand also comprises a telescopic pole means comprising an inner tube, and an outer tube, which tubes telescopically can be moved in relation to each other. The stand also comprises a lock means arranged on said inner tube, and operable to releaseably lock said tubes in relation to each other. The stand also comprises a coupling means arranged at a first end of said inner tube, and operable to secure said screen when it is at least partly withdrawn from said bobbin. The stand also comprises a damper means comprising a first part arranged on said inner tube, and a second part arranged on said outer tube. The damper means is operable to exert a damping force when said tubes are moved in relation to each other with at least a predetermined threshold velocity value.

The advantage with this solution is that when the pole means is pulled out or pushed in, with a low controlled speed, there is no resistance in the damper means, but when/if the uncontrolled situation described above occurs, the damper means exert a damping force, avoiding the uncontrolled situation.

A further advantage in this context is achieved if said damper means is an air damper means, and in that said first part is secured at a second end of said inner tube, and comprises a sealing means abutting and sealing against an inner side of said outer tube.

Furthermore, it is an advantage in this context if said second part is secured at an inner side of said outer tube in an airtight way.

A further advantage in this context is achieved if said sealing means is a gasket of rubber.

Furthermore, it is an advantage in this context if said gasket is an O-ring arranged in a groove in said first part.

A further advantage in this context is achieved if said outer tube comprises an air outlet arranged in the vicinity of said second part, between said second part and said first part.

Furthermore, it is an advantage in this context if said air outlet is a through hole in said outer tube.

According to another embodiment, it is an advantage if said damper means is a liquid damper means, and in that said liquid damper means also comprises a third part arranged at one end of said outer tube, through which third part of said inner tube is running.

A further advantage in this context is achieved if between said second part and said second part and said third part is arranged a liquid chamber filled with liquid.

Furthermore, it is an advantage in this context if said first part is arranged in the vicinity of a second end of said inner tube, and is a piston provided with through holes substantially arranged in parallel with said inner tube whereby said liquid is forced to pass said through holes when said tubes are moved in relation to each other.

A further advantage in this context is achieved if said second part is a liquid tight sealing, and in that said third part is also a liquid tight sealing.

Furthermore, it is an advantage in this context if said liquid is oil.

A further advantage in this context is achieved if said lock means is an eccentric lock means.

Furthermore, it is an advantage in this context if said bobbin is actuated by a spring arrangement adapted to act on said screen with decreasing power of force during a screen wind-up phase and with increasing power of force during a screen unwinding phase.

It will be noted that the term “comprises/comprising” as used in this description is intended to denote the presence of a given characteristic, step or component, without excluding the presence of one or more other characteristic features, integers, steps, components or groups thereof.

Embodiments of the invention will now be described with reference to the accompanying drawings, in which:

### BRIEF DESCRIPTION OF THE DRAWINGS

FIG. 1 illustrates assembly sequences A-G, applicable to an earlier known display means;

FIG. 2 is a cross section view of a first embodiment of the display means according to the present invention;

FIG. 3 is a perspective view, partially exploded, of said first embodiment of the display means disclosed in FIG. 2; and

FIG. 4 is a side view, partially in cross section, of a second embodiment of the display means according to the present invention.

### DETAILED DESCRIPTION

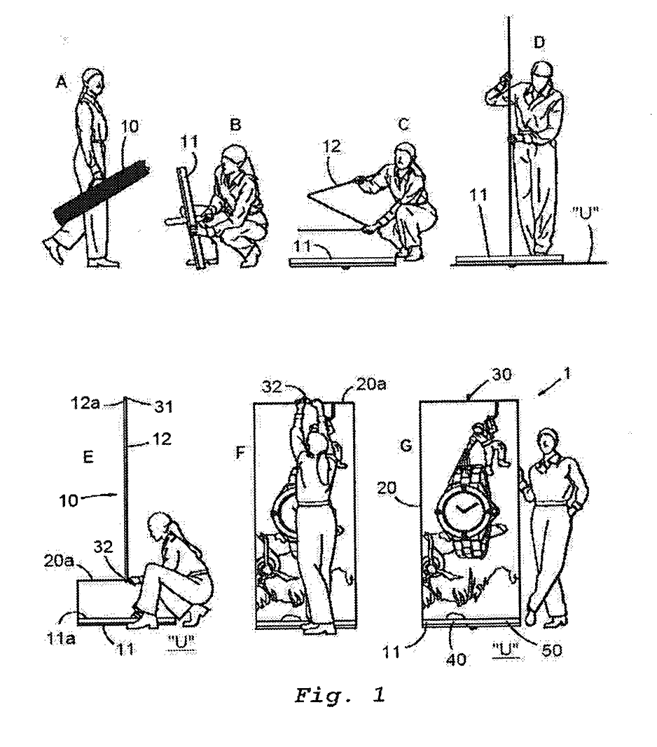

In FIG. 1 there is disclosed a more or less complete assembly sequence with the aid of individual assembly steps referenced A-G of a display means 1, this assembly sequence or erection sequence also being applicable to the display means 1 according to the present invention.

According to step A, the display means 1 comprises a stand 10, which in a fully erected state (steps F, G) firmly supports a screen 20, wherein the stand 10 comprises a first part 11 which supports against an underlying supportive surface U (step D), and further includes a foldable part 12 which, when the stand 10 is erected, extends upwardly from the first part 11.

One upwardly extending end part 12a of the second part 12 (step E) has a first coupling element 31 included in a two-part coupling arrangement 30, where—with the other coupling element 32 of the coupling arrangement is joined to the screen 20 either directly or indirectly, and orientated in connection with the upper edge part 20a of the screen 20.

The screen 20 can be wound onto and unwound from a bobbin 40 enclosed in a cavity (not shown) located in the first part 11, wherein the bobbin 40 can be actuated by a spring arrangement 50 that includes an associated spring unit.

The spring arrangement 50 is designed to act on the screen 20 with a decreasing force during a screen wind-up phase (the steps from F to E) with the aid of a spring unit consisting of helically twisted or wound metal wire, wherewith the screen 20 is acted upon at an increasing force during an unwinding phase (the steps from E to F).

The spring arrangement 50 is also adapted to act on the screen 20 with a chosen initial power when the screen 20 has been fully wound around the bobbin 40 (in accordance with the step D).

The first part 11 includes a slot 11a through which the screen 20 passes so as to be unwound from or wound onto the bobbin 40 present in the cavity.

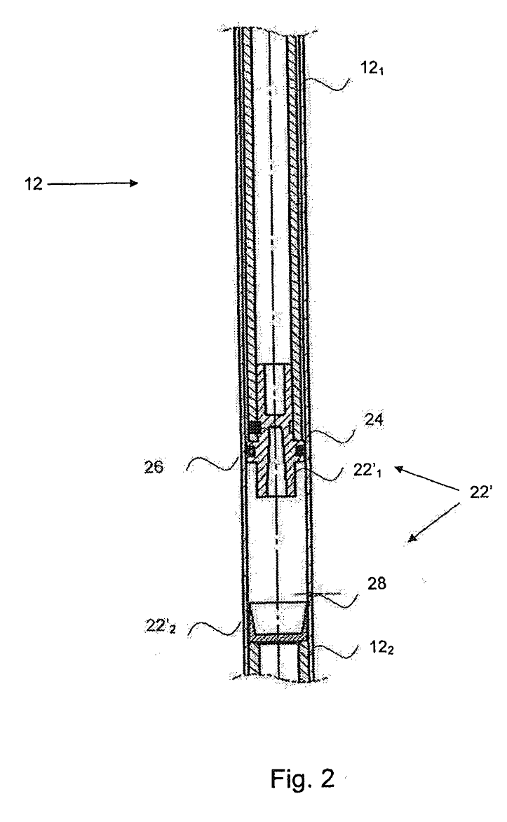

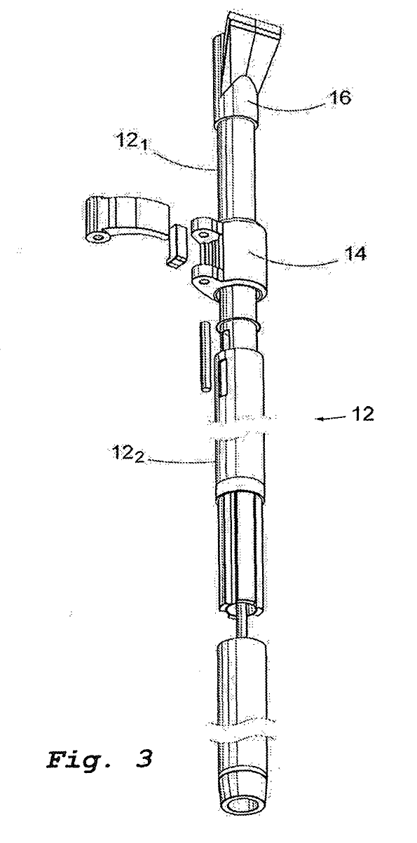

In FIG. 2 there is disclosed a cross section view of a first embodiment of the display means 1 according to the present invention. In FIG. 3 there is disclosed a perspective view, partially exploded, of the first embodiment of the display means 1 disclosed in FIG. 2. Actually, it is not the complete display means 1 that is disclosed. As is apparent in FIGS. 2 and 3, the stand 10 comprises a telescopic pole means 12, comprising an inner tube 12, and an outer tube 12₂, which tubes 12₁, 12₂ can be telescopically moved in relation to each other. The stand 10 (see FIG. 3) also comprises a lock means 14, in FIG. 3 in the form of an eccentric lock means 14, arranged on the inner tube 12₁ and operable to releaseably lock the tubes 12₁, 12₂ in relation to each other. The stand 10 (see FIG. 3) also comprises a coupling means 16 arranged at a first end of the inner tube 12₁, and operable to secure the screen 20 when it is at least partly withdrawn from the bobbin 40 (see FIG. 1). The stand 10 also comprises a damper means 22′, in FIGS. 2 and 3 in the form of an air damper means 22′. The air damper means 22′ comprises a first part 22′₁, and a second part 22′₂ arranged on the outer tube 12₂. The first part 22′₁ is secured at a second end of the inner tube 12₁, and comprises a sealing means 24 abutting and sealing against an inner side of the outer tube 12₂. In FIGS. 2 and 3, the sealing means 24 is in the form of an O-ring 24 arranged in a groove 26 in the first part 22′₁. The second part 22′₂ is secured at an inner side of the outer tube 12₂ in an airtight way. As is apparent e.g. in FIG. 2, the outer tube 12₂ comprises an air outlet 28 arranged in the vicinity of the second part 22′₂, between the second part 22′₂ and the first part 22′₁. In FIG. 2, the air outlet 28 is in the form of a through hole 28 in the outer tube 12₂.

This air damper means 22′ has the advantage that when it is pulled out or pushed in, with a low controlled speed, there is no resistance, but when/if the uncontrolled situation described above occurs, i.e. the roll up mechanism is pulling the screen 20 with a high speed in an uncontrollable manner into the cassette 11, the air that is let out is restricted due to its high speed through a small diameter hole, thereby damping the speed into a controlled movement.

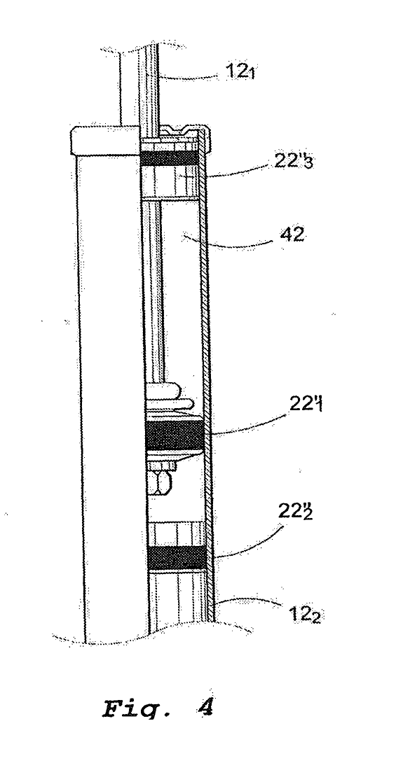

In FIG. 4, there is disclosed a side view, partially in cross section, of a second embodiment of the display means 1 according to the present invention. Actually, it is not the complete display means 1 that is disclosed. This damper means 22″ is a liquid damper means 22″, which also comprises a first part 22″₁, and a second part 22″₂ arranged on the outer tube 12₂. The liquid damper means 22″ also comprises a third part 22″₃ arranged at one end of the outer tube 12₂. As is apparent in FIG. 4, the inner tube 12₁ is running through said third part 22″₃. A liquid chamber 42 is arranged between the second part 22″₂ and the third part 22″₃, which chamber 42 is filled with a liquid. The first part 22″₁ is arranged in the vicinity of a second end of the inner tube 12₁, and is a piston 22″₁ provided with a number of through holes substantially arranged in parallel with the inner tube 12₁. Then the tubes 12₁, 12₂ are moved in relation to each other, the liquid in the chamber 42 is forced to pass through the through holes. The second part 22″₂ and the third part 22″₃ are each a liquid tight sealing 22″₂, 22″₃. The liquid can e.g. be oil.

This liquid damper means 22″ has the advantage that when it is pulled out or pushed in, with a low controlled speed, there is no resistance, but when/if the uncontrolled situation described above occurs, i.e. the roll up mechanism is pulling the screen 20 with a high speed in an uncontrollable manner into the cassette 11, the liquid that is passed the through holes is restricted due to its high speed through small diameter holes, thereby damping the speed into a controlled movement.

It will be understood that the present invention is not restricted to the above mentioned embodiments, and that a person skilled in this art will be aware of the fact that many modifications are possible within the scope of the accompanying claims.

1. A display means comprising a stand adapted to secure a screen, wherein the stand comprises a first part which supports against an underlying supportive surface and comprises a bobbin enclosed in a cavity in said first part, wherein said screen can be wounded onto and withdrawn from said bobbin, characterized in that said stand also comprises a telescopic pole means comprising an inner tube and an outer tube, which tubes telescopically can be moved in relation to each other, wherein said stand also comprises a lock means arranged on said inner tube and operable to releaseably lock said tubes in relation to each other, a coupling means arranged at a first end of said inner tube and operable to secure said screen when it is at least partly withdrawn from said bobbin, and a damper means comprising a first part arranged on said inner tube, and a second part arranged on said outer tube, wherein said damper means is operable to exert a damping force when said tubes are moved in relation to each other with at lease a predetermined threshold velocity value.

2. A display means according to claim 1, characterized in that said damper means is an air damper means, and in that said first part is secured at a second end of said inner tube, and comprises a sealing means abutting and sealing against an inner side of said outer tube.

3. A display means according to claim 2, characterized in that second part is secured at an inner side of said outer tube in an airtight way.

4. A display means according to claim 3, characterized in that said sealing means is a gasket of rubber.

5. A display means according to claim 4, characterized in that said gasket is an O-ring arranged in a groove in said first part.

6. A display means according to claim 2, characterized in that said outer tube comprises an air outlet arranged in the vicinity of said second part, between said second part and said first part.

7. A display means according to claim 6, characterized in that said air outlet is a through hole in said outer tube.

8. A display means according to claim 1, characterized in that said damper means is a liquid damper means, and in that said liquid damper means also comprises a third part arranged at one end of said outer tube, through which third part said inner tube is running.

9. A display means according to claim 8, characterized in that between said second part and said third part is arranged a liquid chamber filled with liquid.

10. A display means according to claim 9, characterized in that said first part is arranged in the vicinity of a second end of said inner tube, and is a piston provided with through holes substantially arranged in parallel with said inner tube whereby said liquid is forced to pass said through holes when said tubes are moved in relation to each other.

11. A display means according to claim 8, characterized in that said second part is a liquid tight sealing, and in that said third part also is a liquid tight sealing.

12. A display means according to claim 8, characterized in that said liquid is oil.

13. A display means according to claim 1, characterized in that said lock means is an eccentric lock means.

14. A display means according to claim 1, characterized in that said bobbin is actuated by a spring arrangement adapted to act on said screen with decreasing power of force during a screen wind-up phase and with increasing power of force during a screen unwinding phase.
